(19) United States
(12) Patent Application Publication
(10) Pub. No.: US 2020/0132552 A1
(43) Pub. Date: Apr. 30, 2020

(54) METHOD AND ASSEMBLY FOR MEASURING A GAS TEMPERATURE DISTRIBUTION IN A COMBUSTION CHAMBER

(71) Applicant: Siemens Aktiengesellschaft, MÜNCHEN (DE)

(72) Inventors: HANS-GERD BRUMMEL, BERLIN (DE); KAI HEESCHE, MÜNCHEN (DE); VOLKMAR STERZING, NEUBIBERG (DE)

(21) Appl. No.: 16/493,766

(22) PCT Filed: Mar. 13, 2018
(86) PCT No.: PCT/EP2018/056297

§ 371 Date: Sep. 13, 2019

(30) Foreign Application Priority Data
Mar. 16, 2017 (DE) 10 2017 204 434.9

(51) Int. Cl. G01J 5/60; G01J 5/00; G01J 5/04; G01J 5/08; G01J 3/42; G01M 15/14

(52) U.S. Cl. CPC G01J 5/602; G01J 5/0088; G01J 5/042; G01J 5/0806; G01J 2005/0077; G01J 5/0896; G01J 3/42; G01M 15/14; G01J 2005/0048; G01J 5/0862

(57) ABSTRACT

Provided is an optical sensor directed into a combustion chamber is used to selectively sense a predefined spectral range of an optical spectrum for different light paths running through the combustion chamber to measure a gas temperature distribution in the combustion chamber. A spectral intensity is determined for each spectral range and associated with an item of light path information which identifies the light path in question. The spectral intensities determined and and the associated items of light path information are fed as input data to a machine learning routine which is trained to reproduce spatially resolved training temperature distributions. Output data from the machine learning routine are then output as the gas temperature distribution.

### CROSS-REFERENCE TO RELATED APPLICATIONS

This application claims priority to PCT Application No. PCT/EP2018/056297, having a filing date of Mar. 13, 2018, which is based on German Application No. 10 2017 204 434.9, having a filing date of Mar. 16, 2017, the entire contents both of which are hereby incorporated by reference.

### FIELD OF TECHNOLOGY

In combustion chambers, in particular of combustion engines, a combustion process frequently takes place at very high temperatures, pressures and/or flow velocities. In a gas turbine, for example, temperatures of approximately 1300-2000° C., pressures of approximately 15 to 25 bar and flow velocities of approximately 300 m/s can occur. To optimize the construction and the operation of a combustion engine, in particular with respect to the efficiency thereof, the exhaust gas emissions thereof and/or the wear thereof, it is of great use to capture and evaluate information relating to a temperature distribution in the combustion chamber. Since especially local temperature peaks frequently result in stronger nitrogen oxide emissions and greater wear, it would be highly advantageous to not only capture a temperature average value here, but in particular to capture a measure of an inhomogeneity or unequal distribution of the gas temperature.

### BACKGROUND

Among the above-mentioned physical ambient conditions, it is frequently possible only with great limitations to directly measure gas temperatures prevailing in the combustion chamber by measurement probes that are mounted there. Owing to this difficulty, temperature measurements in known combustion engines are generally performed at a gas outlet of the combustion engine. Starting from the temperatures measured there and the prevailing almost atmospheric pressures, a back-calculation to the higher values in the combustion chamber is then performed. However, in this way it is in many cases possible to ascertain only average values of the gas temperature in the combustion chamber. While it is frequently possible to obtain from these average values estimates relating to a temperature distribution in the combustion chamber by way of thermodynamic models of the combustion engine, the estimates often only reflect a model structure.

### SUMMARY

An aspect relates to a method and an arrangement for measuring a gas temperature distribution in a combustion chamber which permit more accurate ascertainment of the gas temperature distribution.

For measuring a gas temperature distribution in a combustion chamber, in particular of a combustion engine, in each case a specified spectral range of an optical spectrum is selectively captured for different light paths passing through the combustion chamber using an optical sensor that is directed into the combustion chamber. The optical spectrum can here in particular be an infrared spectrum, an ultraviolet spectrum and/or a spectrum in the visible light. A respective spectral intensity is ascertained here for a respective spectral range and assigned to a light path indication identifying the respective light path. The spectral intensities ascertained and the assigned light path indications are supplied as input data to a machine learning routine that is trained for a reproduction of spatially resolved training temperature distributions. Output data of the machine learning routine are then output as the gas temperature distribution. In this case, in particular a spatial temperature distribution, a measure of spatial inhomogeneity or unequal distribution of the gas temperature and/or a temperature frequency distribution can be output as the gas temperature distribution.

For performing the method according to embodiments of the invention, an arrangement for measuring the gas temperature distribution, a computer program product (non-transitory computer readable storage medium having instructions, which when executed by a processor, perform actions) and a computer-readable storage medium are provided.

The method according to embodiments of the invention and the arrangement according to embodiments of the invention can be embodied or implemented for example by way of one or more processors, application specific integrated circuits (ASIC), digital signal processors (DSP) and/or what are known as “field programmable gate arrays” (FPGA).

One advantage of embodiments of the invention should be considered to be the fact that it permits relatively exact ascertainment of a gas temperature distribution in a combustion chamber without being reliant on temperature sensors that project into the combustion chamber. By using a machine learning routine, even complex correlations between the light-path-specific and thus spatially resolved spectral intensities and the gas temperature distribution in the combustion chamber can be modeled relatively accurately. This is also true in particular for different operating states of the combustion chamber. The gas temperature distribution ascertained and in particular the inhomogeneity thereof can be used to monitor operation of the combustion chamber, to test the combustion chamber, to optimize efficiency and/or to minimize ejection of harmful substances and/or wear.

Advantageous embodiments and developments of the invention are specified in the dependent claims.

The machine learning routine can utilize a data-driven trainable regression model, an artificial neural network, a recurrent neural network, a convolutional neural network, an autoencoder, a deep learning architecture, a support-vector machine, a k-nearest neighbors classifier, a physical model and/or a decision tree.

According to embodiments of the invention, the spectral range selected can be specifically spectral lines of one or more substances, the concentration of which in the combustion chamber is temperature-dependent. The spectral lines can here be absorption or emission lines. Substances selected can be compounds that are produced or are otherwise converted during combustion. Frequently, specific temperatures or temperature thresholds are characteristic of such conversions, such that a strong correlation and consequently a characteristic relationship between the intensity of the relevant spectral lines and a local gas temperature exists. Such substances can therefore be used as temperature markers, as it were. Nitrogen oxides can be used as temperature markers within the meaning of embodiments of the invention. The capturing of the spectral intensities of nitrogen oxides or other harmful substances can additionally be used to measure and possibly optimize harmful-substance emission.

According to a further advantageous embodiment, the optical spectrum for the different light paths can be captured in parallel and direction-sensitively using a camera as an optical sensor. The camera can here in particular be an infrared camera, an ultraviolet camera and/or a camera sensitive to visible light.

The spectral range can furthermore be selected using a narrowband spectral filter.

According to embodiments of the invention, one or more laser beams can be transmitted through the combustion chamber along different light paths and, after passage through the respective light path, be captured by the optical sensor. A laser frequency can here be tuned to a respective spectral range or to a respective spectral line.

The different light paths can advantageously be selected via direction and/or position changes of the optical sensor, of a laser directed into the combustion chamber and/or of a mirror and/or prism arranged along a respective light path. It is thus possible in a simple manner to select a multiplicity of light paths. The light path indications can here comprise indications relating to position and/or orientation of the optical sensor, of the laser, of the mirror and/or of the prism.

According to embodiments of the invention, the machine learning routine can be trained in a calibration phase using a training combustion chamber on the basis of specified temperature distribution data.

Moreover, a thermodynamic model of the combustion chamber can be used to ascertain a correlation between further operating data of the combustion chamber and a temperature distribution in the combustion chamber and be used for training the machine learning routine.

Furthermore, further operating data of the combustion chamber can be supplied as input data, together with the spectral intensities and the light path indications, to the machine learning routine. By taking the further operating data into account, generally the accuracy of the ascertained gas temperature distribution is improved.

In particular, it is possible on the basis of the further operating data and of the output gas temperature distribution to train a soft sensor for a reproduction of the gas temperature distribution on the basis of the further operating data. Using the trained soft sensor, it is then possible to at least estimate the gas temperature distribution on the basis of the further operating data without requiring an optical sensor. This allows the use of the trained soft sensor even in combustion engines in which the interior of the combustion chamber is optically not accessible, or accessible only with difficulty.

Moreover, a training structure of the trained machine learning routine can be specifically extracted and transferred to a soft sensor. Such a transfer is frequently also referred to as transfer learning. The transfer can in many cases shorten or even replace training of the soft sensor.

### BRIEF DESCRIPTION

Some of the embodiments will be described in detail, with references to the following Figures, wherein like designations denote like members, wherein:

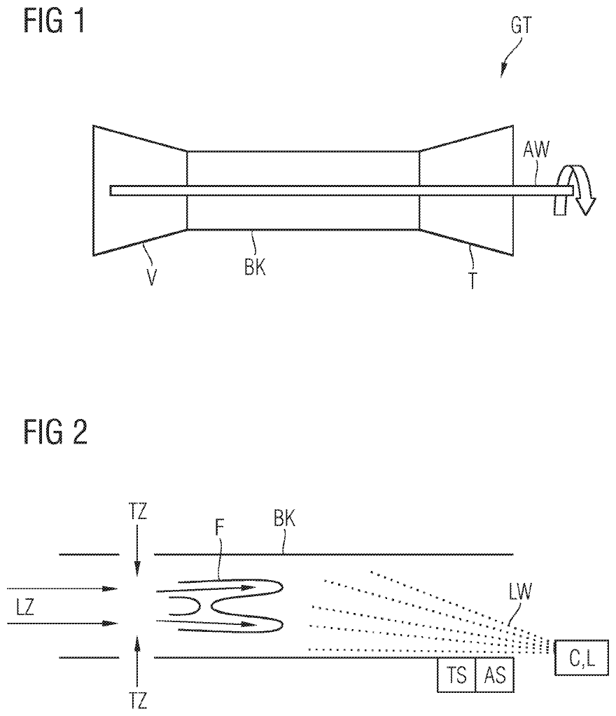

FIG. 1 shows a gas turbine with a combustion chamber;

FIG. 2 shows a tubular combustion chamber with an optical sensor for measuring a gas temperature distribution;

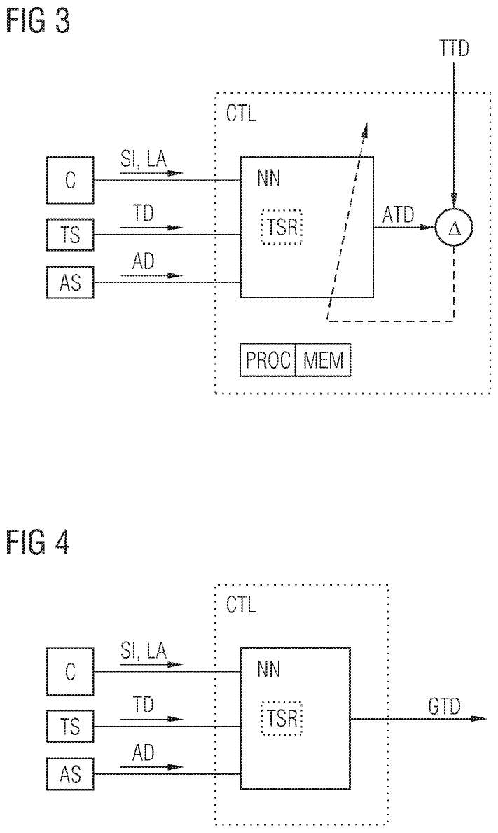

FIG. 3 shows training of an arrangement according to embodiments of the invention for measuring a gas temperature distribution; and

FIG. 4 shows a measurement of a gas temperature distribution using the trained arrangement.

### DETAILED DESCRIPTION

FIG. 1 shows, as an application example of embodiments of the invention, a schematic illustration of a gas turbine GT having a combustion chamber BK, in which a gas temperature distribution is to be measured during operation. The gas turbine GT has a compressor V for compressing inflowing air, the combustion chamber BK for burning supplied fuel and a turbine T for converting thermal and kinetic energy produced by the combustion into rotational energy. The latter is transferred, via a drive shaft AW, among other things to the compressor V so as to drive the latter.

The embodiments can additionally serve for measuring gas temperature distributions in combustion chambers of internal combustion engines, jet engines or other combustion engines.

FIG. 2 shows a schematic illustration of a tubular combustion chamber BK having an optical sensor C for measuring a gas temperature distribution in the combustion chamber BK. The combustion chamber BK can in particular be a combustion chamber or a combustion space of a gas turbine, of an internal combustion engine, of a jet engine or of another combustion engine. The combustion chamber BK has an air supply LZ and fuel supplies TZ. The fuel is mixed with the supplied air and burned in a flame F. The flame F generally has an inhomogeneous temperature distribution both over a cross section of the combustion chamber BK and also along the combustion chamber BK. For example, temperatures of approximately 1400-2000° C. can develop in the region of the flame F and for example approximately 1000° C. can develop at a perimeter of the combustion chamber BK. Local temperature peaks in particular are relevant for the wear of the combustion chamber BK or the gas turbine GT.

Frequently, a strong gas flow which transports a temperature distribution from the region of the flame F along the combustion chamber BK forms along the combustion chamber BK. Owing to a typically occurring expansion of the flowing gas, in particular in a turbine or turbine stage, the temperature thereof during transport generally significantly decreases. Nevertheless, the temperature arriving at the outlet generally correlates to a temperature in the region of the flame F. The method according to embodiments of the invention of the gas temperature distribution measurement is based on the observation that the correlation can be learned quite successfully with available machine learning routines.

As an optical sensor, a camera C is directed into the combustion chamber BK. The camera C can in particular be an infrared camera, an ultraviolet camera and/or a camera that is sensitive to visible light. A spatially resolving or direction-resolving spectrometer can likewise be used as the camera C. In particular, camera arrangements which have previously been used for observing turbine blades, can be modified such that they can capture a spatially resolved optical spectrum.

The camera C is arranged relative to the combustion chamber BK such that it can capture an optical spectrum for different light paths LW passing through the combustion chamber BK. The optical spectrum can here in particular be an infrared spectrum, an ultraviolet spectrum and/or a spectrum in the visible light. With appropriate resolution, the camera C can capture a multiplicity of light paths LW in parallel and nearly simultaneously. For this purpose, an opening or another light passage, for example a window made from heat-resistant glass, can be mounted on the combustion chamber BK. In the case of a jet engine, the camera C can be directed into an open outlet of the combustion chamber BK. Moreover, a mirror and/or a prism can also be used to redirect the light paths LW into the camera C. The camera C and possibly the mirror and/or the prism are arranged such that light paths LW that extend longitudinally through the combustion chamber BK can be captured.

The camera C captures for the light paths LW in each case one or more specifically prescribed spectral ranges of an optical spectrum, in particular an emission and/or absorption spectrum. In this case, each captured spectral range is assigned a light path indication that identifies the light path LW for which the spectral range was captured. In particular, a piece of direction information relating to the relevant light path LW can be assigned as the light path indication. In a two-dimensional camera image, image coordinates of a respective image point can be assigned as the light path indication.

The spectral ranges can be extracted from the captured optical spectrum using one or more narrowband spectral filters. Such a spectral filter can be embodied for example as a frequency or wavelength filter and as an analog or digital spectral filter. In particular, the spectral filter can select specific frequency and/or wavelength channels, or specific dimensions of a high-dimensional data vector representing the optical spectrum. Alternatively or additionally, the light paths LW can be guided through a transmission spectral filter that is arranged upstream of the camera C or a mirror or prism.

Specific spectral lines of emission or absorption spectra of one or more substances, the concentration of which in the combustion chamber BK is strongly temperature-dependent, are selected as spectral ranges. For this purpose, in particular emission or absorption lines of gaseous combustion products, molecules, molecular compounds and/or radicals are selected, which are formed only or above specific temperature thresholds in the combustion chamber BK and possibly decompose again at lower temperatures. Spectral lines of nitrogen oxides such as NO, N₂O, NO₂ and/or other compounds that typically occur in predetermined high-temperature ranges are selected. In the case of such substances, a non-linear, frequently exponential increase or drop in the concentration thereof with the temperature occurs, such that there is a strong correlation and consequently a characteristic relationship between the intensity of the relevant spectral lines and the local gas temperature. Such substances can consequently be used as temperature markers, as it were.

Using the camera C, selectively narrowband spectral ranges with emission and/or absorption spectra of substances used as temperature markers are thus captured in a light-path-specific manner, as a two-dimensional image. On account of the selection of narrowband spectral ranges from the optical spectrum, the characteristic spectra of the substances used as temperature markers can be separated well from the continuous thermal radiation of the combustion chamber walls. This continuous thermal radiation would allow for only relatively inaccurate conclusions as to the gas temperature distribution to be drawn.

The optical sensor, here the camera C, can also be combined with one or more lasers L directed into the combustion chamber BK. The laser(s) L here transmit a multiplicity of laser beams along the light paths LW, for example using a time-division or space-division multiplexing method. The frequency of the laser beams is here tuned to one or more spectral lines of the temperature markers so as to detect the absorption or excitation spectrum thereof. The scattered light of the back-scattered laser beams is captured in a direction-sensitive manner using the camera C and assigned to a light path LW of the respectively causing laser beam. An absorption of the laser energy on the relevant light path and thus a concentration of the absorbing substance can be ascertained in a light-path-specific manner on the basis of the scattered light. Alternatively, or additionally, provision may be made for the laser(s) L to radiate light through the combustion chamber BK in the longitudinal direction. To this end, a first light passage for entry of the laser beams into the combustion chamber BK and a light passage located opposite the former for exit of the laser beams can be provided.

Different light paths LW through the combustion chamber BK can be set and/or selected easily by displacing and/or rotating the camera C, the laser(s) L, a mirror and/or a prism. It is thus possible to capture the spectral ranges on a grating or fans of light paths from a greater region of the combustion chamber BK.

According to embodiments of the invention, in each case one or more spectral intensities for a respective light path LW and a respective spectral range is/are ascertained and assigned to the relevant light path LW by way of a light path indication.

In addition to the spectral intensities, further operating data of the combustion chamber BK and/or of the combustion engine that are accessible from outside are captured and evaluated during ascertainment of the gas temperature distribution. Such operating data can comprise, for example, current physical, control-technological, effect-dependent and/or construction-dependent state variables, operating parameters, properties, performance data, effective data, system data, specified values, control data, environment data, sensor data, measurement values or other data relevant during the operation of the combustion engine. In the present exemplary embodiment, exhaust gas temperatures measured using a temperature sensor TS and exhaust gas emissions measured using an exhaust gas sensor AS are captured as further operating data. The exhaust gas sensor AS in particular measures a composition of the exhaust gases.

The temperature sensor TS and the exhaust gas sensor AS can be arranged on the combustion chamber BK and/or downstream of a turbine. A plurality of temperature sensors TS and/or exhaust gas sensors AS can also possibly be provided. In particular, a grating or a ring of temperature sensors TS or exhaust gas sensors AS can be situated downstream of the combustion chamber BK or of a turbine.

Taking the further operating data into account generally significantly improves an accuracy of the ascertained gas temperature distribution.

FIG. 3 illustrates a training of an arrangement according to embodiments of the invention for measuring a gas temperature distribution in a combustion chamber. Identical entities are designated in FIG. 3 with the same reference signs as in FIG. 2 and can be embodied as described therein.

The arrangement according to embodiments of the invention in the present exemplary embodiment comprises a camera C, possibly in combination with one or more lasers, a temperature sensor TS, an exhaust gas sensor AS and a turbine controller CTL. The turbine controller CTL, the camera C, the temperature sensor TS and the exhaust gas sensor AS can be operated for training purposes in particular on a training combustion chamber that provides information relating to an actual spatially resolved gas temperature distribution in the interior of the combustion chamber in the form of training temperature distributions TTD.

The turbine controller CTL is provided with one or more processors PROC for performing method steps of the turbine controller CTL and one or more memories MEM, coupled to the processor PROC, for storing the data that are to be processed by the turbine controller CTL. The camera C, the temperature sensor TS and the exhaust gas sensor AS are coupled to the turbine controller CTL.

The turbine controller CTL in the present exemplary embodiment has an artificial neural network NN as a constituent part of a data-driven machine learning routine. The neural network NN is capable of learning or being trained in a data-driven fashion and has a training structure TSR that develops during training.

In this context—as per the linguistic use in the art training is understood to be mapping input data of the neural network NN onto one or more target variables which is optimized according to specifiable criteria during a training phase. The training structure TSR of the neural network NN that is optimized in view of the specified criteria is developed in the process. The training structure TSR can comprise for example a network structure of neurons of the neural network and/or weightings of connections between the neurons which are developed during training such that the specified criteria are met as well as possible.

In the present exemplary embodiment, the neural network NN receives from the camera C for different light paths in each case one or more spectral intensities SI for a respective spectral range and a light path indication LA identifying the respective light path as input data. The neural network NN receives further operating data of the combustion chamber and/or of the combustion engine as further input data. In the present exemplary embodiment, these are temperature data TD from the temperature sensor TS and exhaust gas data AD from the exhaust gas sensor AS. The temperature data TD here describe an exhaust gas temperature of the combustion chamber, and the exhaust gas data AD describe an exhaust gas composition, in particular of nitrogen oxide emissions.

The neural network NN is to be trained such that the output data ATD thereof reproduce the gas temperature distribution of the training combustion chamber as a target variable as well as possible. The gas temperature distribution is here in particular to be understood to be a measure of a spatial inhomogeneity or unequal distribution of the gas temperature and/or to be a temperature frequency distribution. The output data ATD are output in the form of temperature distribution data.

In a calibration phase, a neural model that models a dependence of the distribution of the combustion products on the temperature distribution is learned by way of the neural network NN, starting from exhaust gas emissions, for example nitrogen oxide emissions, and average exhaust gas temperatures that can be derived from modeled temperature distribution data using a physical thermodynamic model of the combustion chamber. Correlations between changes in spectral intensities and changes in the exhaust gas composition are modeled here.

Furthermore, the spatially resolved training temperature distributions TTD are supplied to the neural network NN. The neural network NN is here trained such that the output data ATD derived from the received spectral intensities SI, the assigned light path indications LA and the further operating data TD and AD reproduce the training temperature distributions TTD as well as possible. To this end, the output data ATD are compared to the training temperature distributions TTD for example by ascertaining a distance between the output data ATD and the training temperature distributions TTD by subtraction. The distance represents a prediction error of the neural network NN and is fed back to it. The neural network NN is trained on the basis of the fed-back distance—as indicated by a dashed arrow—to minimize the distance on average. In this way, the training structure TSR is developed and the neural network NN is enabled to output, on the basis of the supplied input data, in the present case SI, LA, TD and AD, a relatively exact estimate of the gas temperature distribution.

The training temperature distributions TTD can be measured in a training combustion chamber, in particular a test combustion chamber from a development or product qualification process, and/or be provided in the form of temperature distribution data.

FIG. 4 illustrates a measurement of a gas temperature distribution using the trained arrangement from FIG. 3. Identical entities in FIG. 4 are designated with the same reference signs as in FIG. 3 and can be embodied as described therein.

The measurement of the gas temperature distribution is performed on the combustion chamber BK described in FIG. 2 during production operation. In each case one or more spectral intensities for a respective spectral range and a light path indication LA identifying the respective light path are supplied here as input data to the neural network NN by the camera C for different light paths. The neural network NN receives further operating data of the combustion chamber BK and/or the combustion engine GT as further input data. In the present exemplary embodiment, these are temperature data TD from the temperature sensor TS and exhaust gas data AD from the exhaust gas sensor AS. The input data are in each case captured instantaneously, in real time.

Using the developed training structure TSR, output data that are output as gas temperature distribution GTD are derived by the trained neural network NN from the input data, in particular from the spectral intensities SI and the intensity ratios thereof. It is apparent that in particular local temperature peaks in the combustion chamber BK that have a significant influence on exhaust gas emissions and wear are able to be modeled and thus to be reproduced relatively accurately.

The gas temperature distribution GTD that is output can be used for controlling the gas turbine GT. In particular in order to optimize the efficiency thereof, for example by increasing an average combustion temperature, and/or to reduce the wear and/or harmful-substance ejection thereof

It is furthermore possible using the trained neural network NN to train a soft sensor (not illustrated) on the basis of the further operating data TS and AD for a reproduction of the output gas temperature distribution GTD. The training structure TSR of the trained neural network NN can advantageously be wholly or partly extracted and transferred to the soft sensor. Using the trained soft sensor, it is then possible to at least estimate the gas temperature distribution within the combustion chamber BK on the basis of the further operating data without requiring a camera. A soft sensor that has been trained in this way can then be used to estimate a gas temperature distribution even in combustion engines in which no camera image of the interior of the combustion chamber is available.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for measuring a gas temperature distribution in a combustion chamber, wherein
a) in each case a specified spectral range of an optical spectrum is selectively captured for different light paths passing through the combustion chamber using an optical sensor that is directed into the combustion chamber.
b) a respective spectral intensity is ascertained fora respective spectral range and assigned to a light path indication identifying the respective light path.
c) the spectral intensities ascertained and the assigned light path indications are supplied as input data to a machine learning routine that is trained for a reproduction of spatially resolved training temperature distributions, and
d) output data of the machine learning routine are output as gas temperature distribution.

2. The method as claimed in claim 1, wherein the machine learning routine utilizes at least one of a data-driven trainable regression model, an artificial neural network, a recurrent neural network, a convolutional neural network. an autoencoder, a deep learning architecture, a support-vector machine, a k-nearest neighbors classifier, a physical model and-or a decision tree.

3. The method as claimed in claim 1, wherein specific spectral lines of one or more substances, the concentration of which in the combustion chamber is temperature-dependent, are selected as the spectral range

4. The method as claimed in claim 1, wherein the optical spectrum for the different light paths is captured in parallel and direclion-sensitively using a camera as the optical sensor.

5. The method as claimed in claim 1, wherein the spectral range is selected using a spectral filter.

6. The method as claimed in claim 1, wherein one or more laser beams are transmitted through the combustion chamber along different light paths and, after passage through the respective light path, are captured by the optical sensor.

7. The method as claimed in claim 1, wherein the different light paths are selected via at least one of direction and of position changes of the optical sensor, of a laser directed into the combustion chamber and/or of a mirror and or prism arranged along a respective light path.

8. The method as claimed in claim 1, wherein the machine learning routine is trained in a calibration phase using a training combustion chamber on the basis of specified temperature distribution data.

9. The method as claimed in claim 1, wherein a thermody namic model of the combustion chamber is used to ascertain a correlation between further operating data of the combustion chamber and a temperature distribution in the combustion chamber and used for training the machine learning routine.

10. The method as claimed in claim 1, wherein further operating data of the combustion chamber are supplied as input data, together with the spectral intensities and the light path indications, to the machine learning routine.

11. The method as claimed in claim 10, wherein a soft sensor is trained, on the basis of the further operating data and of the output gas temperature distribution, for a reproduction of the gas temperature distribution on the basis of the further operating data.

12. The method as claimed in claim 1, wherein a training structure of the trained machine learning routine is specifically extracted and transferred to a soft sensor.

13. An arrangement for measuring a gas temperature distribution in a combustion chamber, configured for performing a method as claimed in claim 1.

14. A computer program product, comprising a computer readable hardware storage device having computer readable program code stored therein, said program code executable hv a processor of a computer svstem to implement a method, configured for performing a method as claimed in claim 1.

15. A computer-readable storage medium having a computer program product as claimed in claim 14.
